(19) United States
(12) Patent Application Publication
(10) Pub. No.: US 2009/0319362 A1
(43) Pub. Date: Dec. 24, 2009

(54) LOYALTY REWARDS FOR PURCHASING

(76) Inventor: Michael Dashnaw, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/143,974

(22) Filed: Jun. 23, 2008

(51) Int. Cl. G06Q 30/00

(52) U.S. Cl. 705/14.34

(57) ABSTRACT

A method of rewarding consumers for the purchase of companion animal products is provided. The method can include providing a pet product for purchase, providing a procedure whereby a purchaser can identify the purchase of the product, providing a rebate to the purchaser, whereby the rebate is usable for a discount on a pet product or service. In one embodiment, the discount is usable for a discount on pet insurance.

### BACKGROUND

The present invention relates to loyalty rewards for purchasing. The present invention relates more particularly, but not exclusively, to rewarding consumers for purchases of companion animal products.

Currently, the cost of ownership of pets can be a deterrent in a person purchasing a pet or can be a deterrent in a person providing all the benefits that a pet can experience during a full, healthy life. Some of those costs include general health and wellness benefits, veterinarian costs associated with wellness checkups, shots, and medical procedures, pet insurance, pet grooming, pet supplies, pet kenneling, pet pharmaceuticals, among many other costs. This high cost of ownership currently is not tempered by any means, and thus many owners or would-be-owners are stuck either with not providing their pet with the best or the most appropriate health and wellness benefits or without having the financial ability to purchase a pet at all because of the ongoing costs associated with owning a pet. Moreover, according to the AVMA (American Veterinary Medical Association), the average veterinary expenditure per household totaled $366 in 2006, and total veterinary expenditures have increased by approximately $5.5 billion since 2001. Conversely, while expenditures have increased, total trips to the veterinarian's office have decreased from 3.7 times per year in 2001 to 2.7 in 2006. In fact, it has been reported that 22.3% of households did not visit a veterinarian in 2006. This concerning trend highlights the need for incentives to drive consumers to the veterinarians office.

Furthermore, and as an example, companion animal insurance for dogs, cats, and the like is offered to people with these pets as a means to offset the occasional high cost of, for example, medical procedures or other high cost occurrence related to pet. However, it has been found that the amount of people that actually purchase pet insurance is fairly low, especially when compared with other insurances in other markets, for example regular human health insurance or automobile insurance.

Thus, an incentive or reward in the form of reduced costs associated with owning a pet can be offered to the pet owner. Even more importantly, giving the pet owner an incentive or reward for feeding a beneficial pet food to their pet can increase the life of the pet in at least two important ways: 1) the pet will be consuming a healthy pet food and 2) the pet will experience the health and wellness benefits, such as more frequent veterinarian visits. Combining these two benefits result in a healthier and happier life for the pet as well as the pet owner.

Lastly, pet food brand loyalty can be created. The pet owner will see the results of not only feeding the pet the healthier food associated with a certain pet food brand but will be providing their pet a health and wellness benefit, such as increased veterinarian visits. Linking the better food with the more frequent health and wellness benefit can create brand loyalty to the pet food company in addition to the multiple benefits experience by the pet owner and the pet itself.

Thus, a system and method are needed to provide pets with more health and wellness benefits and to create incentives or provide rewards to the pet owner to provide their pet with these health and wellness benefits.

### SUMMARY

To address the current needs and improving upon prior technology, the present invention contemplates a method comprising providing a pet food for purchase by a purchaser, wherein the pet food is manufactured by a manufacturer and sold to the purchaser by a retailer; providing a procedure whereby the purchaser can report a purchase of the pet food; receiving a report of a reported purchase; determining whether the reported purchase is valid; determining whether the reported purchase meets a threshold requirement, wherein the threshold requirement comprises a minimum number of valid purchases by the purchaser; providing a rebate to the purchaser after determining whether the reported purchase is valid and determining whether the reported purchase meets a threshold requirement. The rebate can be in the form of a financial discount for use with a pet benefits provider. The method further contemplates the pet benefits provider being a pet insurance company, a veterinarian, or a pet products retailer. The rebate can comprise sending to the purchaser a financial discount for use with a pet benefits provider. The pet benefits provider can be a pet insurance company. The rebate can be a discount on pet insurance.

A method of improving a pet's health is also contemplated. The method comprises providing a pet food within a package; providing a procedure whereby a purchaser of the pet food is able to identify the purchase of the pet food to one of a manufacturer or a retailer of the pet food; providing a rebate to the consumer after the purchaser identifies itself to the manufacturer; wherein the rebate is usable as a discount with a provider of pet benefits. The pet can be a dog, a cat, or a horse.

A method is also contemplated wherein the method comprises providing a recommendation to a consumer, whereby the recommendation comprises informing the consumer of a pet food to purchase; validating that the consumer made a purchase based on the recommendation; providing a financial discount to the consumer. The financial discount can be a financial discount on pet insurance.

Numerous advantages and additional aspects of the present invention will be apparent from the description of the preferred embodiments and drawings that follow.

### BRIEF DESCRIPTION OF THE SEVERAL VIEWS OF THE DRAWINGS

FIG. 1 depicts an overall flow diagram associated with one embodiment of the present invention.

FIG. 2 depicts an overall flow diagram associated with another embodiment of the present invention.

FIG. 3 depicts an overall flow diagram associated with another embodiment of the present invention.

FIG. 4 depicts an overall flow diagram associated with another embodiment of the present invention.

FIG. 5 depicts an overall flow diagram associated with another embodiment of the present invention.

FIG. 6 depicts an overall flow diagram associated with another embodiment of the present invention.

FIG. 7 depicts an overall flow diagram associated with another embodiment of the present invention.

FIG. 8 depicts an overall flow diagram associated with another embodiment of the present invention.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Such alterations and further modifications in the illustrated device and such further applications of the principles of the invention as illustrated therein as would normally occur to one skilled in the art to which the invention relates are contemplated as within the scope of the invention

The present invention will generally be described as a form of loyalty rewards for consumers after their purchase of a product. The present invention relates more particularly, but not exclusively, to rewarding consumers for purchases of companion animal products. However, it should be understood that while the focus of this description is companion animal products, it is equally applicable to other products, such as human-used or human consumed products.

### Definitions

As used herein, the term “pet” or “companion animal” refers to a domestic animal. Preferably, “companion animal” refers to a domestic canine, feline, rabbit, ferret, horse, cow, or the like. In exemplary embodiments, “companion animal” refers to a canine or feline.

As used herein, the term “purchaser” refers to a person that purchases products or services from a store, including retail stores, or a service provider, and more specifically refers to a customer of a retailer of pet products, such as a pet store, or a service provider of pet benefits, such as a veterinarian. A “purchaser,” as used herein, is synonymous with a “consumer.”

As used herein, the term “provider of pet benefits” refers to an entity that provides products or services for purchase by a purchaser, as defined above. A “provider of pet benefits” can include retailers, such as a pet store, or a service provider of pet benefits, such as a veterinarian.

As used herein, the term “manufacturer” refers to an entity that is in the business of making and selling, either directly or indirectly, a product for purchase by the general public. It should further be understood that the term “manufacturer” can include an outside entity, firm, or company, a representative, agent, or other appointed entity thereof, that is working under the direction, directly, indirectly, or otherwise, of the manufacturer to complete certain tasks for the manufacturer, including any and all of the methods, tasks, and procedures as disclosed herein.

In general, one embodiment of the present invention includes a method of rewarding consumers for their purchase of a companion animal product or service by providing to the consumer a discount that can be used at or for a provider of pet benefits, which, when used or experienced by the animal, results in an increased well-being of the animal. In at least one aspect, the companion animal product can be pet food, such as dog food. In other aspects of the invention, the companion animal product can be grooming supplies, toys, or any other animal product that is found throughout a pet store. In still other aspects, the purchase can be that of a service for the pet, such as insurance, a veterinarian visit, or a grooming visit.

Within the aspects above, the discount can be in the form of a rebate check. In other aspects, the discount can be in the form of a coupon, discount card, or any other type of discount, price reduction, markdown, price cut, or other financial incentive or concession that the purchaser can then use for a discount, or receives as a discount, with a provider of pet benefits.

Within the aspects above or any other aspect, the provider of pet benefits can be a pet insurance company. In other aspects, the provider of pet benefits can be a veterinarian, a pet products retailer, or any other entity that provides benefits to a pet.

In one specific embodiment, a method of providing a discount to a purchaser of a pet product is provided. The method includes providing a pet food for purchase by a purchaser. The pet food can be, for example, one of the various types that are manufactured by the Iams™ brand of The Procter & Gamble Company (P&G). A procedure whereby the purchaser can notify one of the manufacturer and the retailer of the purchaser's purchase is further provided. Next, the method can include determining whether the purchase is a valid purchase and meets a threshold requirement, wherein the threshold requirement comprises a minimum number of valid purchasers by the purchaser. Upon validation and meeting the threshold requirement, the method can further include providing a rebate to the purchaser. The rebate can be in the form of a financial discount for use with a provider of pet benefits.

The methods and steps associated therewith and with many other embodiments of the present invention are described in further detail hereinafter.

### Purchase

The present invention includes, in at least one embodiment, providing a pet food for purchase. Generally, while the term pet food is used herein, it should be understood that any other pet supply or product can be within the realm of being provided for purchase, including grooming and bathing supplies, toys, other foods such as snacks and treats, pet collars and leashes, and any other supply or product that is usually found in a pet store. Providing the pet food, or any other pet product, can be done in any one of multiple ways. For example, a retailer having for sale a pet food is providing the pet food for purchase. Usually, the retailer operates a pet store that contains any number of pet products, as listed above, and receives these products, either directly or through the supply chain, from the manufacturer of the pet product. Once received, the retailer will display it along with many other types or brands of the same products for customers, customarily on store shelves, so that a potential customer, or purchaser, can make a decision as to which type or brand of product they wish to purchase for their pet. It is within the scope of the present invention that providing a pet food for purchase can include not only the retailer displaying the pet food for purchase to a potential purchaser or customer of the retail store but also the supply chain between the manufacturer of the pet food and the retailer, whether it be indirect or direct. For example, P&G's Iams™ brand pet food is manufactured at the discretion of P&G. After manufacturing, it ends up on the retailer's store shelves. In between manufacturing and ending up on store shelves, the pet food or product may go through a single or many channels of distribution. It is within the scope of this invention that providing a pet food for purchase by a purchaser, such as a customer of a retail store, includes all of the potential supply chains or distribution channels between the manufacturer and the retailer. Of course, it also includes a direct, single channel, if it exists, between the manufacturer and the retailer. Further, if the retailer and manufacturer are one in the same, that arrangement is also envisioned under this invention. It should also be understood that other ways exists where a customer can acquire pet food. Other ways include such examples as receiving samples through the mail, receiving samples from veterinarians, receiving “free” samples attached to other purchases, for example if a free bag of dog food is given when purchasing a puppy, or any other way for a customer to receive a pet product. Still other ways include purchasing from the pet food directly from the manufacturer of the pet food. For instance, a consumer can purchase pet food from the manufacturer's website.

### Notification

Once a pet food or product is purchased or acquired by a customer or purchaser, it is envisioned that the customer or purchaser present notification of or report the purchase so that, in the end, the purchaser can eventually receive their rebate or other “reward” for the purchase. Thus, providing a procedure for this notification or reporting is envisioned. It should be understood that “notifying”, “notification”, and “notify” are all used interchangeably with “reporting” and “report”. The procedure of notifying of or reporting the pet food purchase can include notifying the manufacturer, the retailer, or any of the pet benefits providers, including a pet insurance company. Notification can include any number of potential channels for communication of the purchase. Those potential channels can include: collecting proofs of purchase from the pet food package, such as the UPC code, and sending those proofs to the manufacturer along with identification of the purchaser; collecting information from the pet food package itself, such as for example a code, for entry into a website linked to the manufacturer so that the manufacturer can track the purchases of the purchaser; and a loyalty card, such as for example an Iams™ branded loyalty shopping card, that is used by the purchaser whenever a purchase is made, and the card is swiped, like a credit card or other loyalty card, when checking out of a retail store, resulting in the purchases being tracked. Such notification can include the identity of the purchaser, the type of product purchased, the brand of product purchased, the date and place or retailer of purchaser, and any other information surrounding the purchase. Again, such notification can include notifying any of the pet benefits providers, such as pet insurance company, by any of the communication channels above or any other communication channel that allows the purchaser to notify of the purchase.

In one embodiment of the notification procedure as described above, a method of collecting proofs or purchase from the pet food package is disclosed. The purchaser of the pet food collects from the package a proof of purchase, such as a UPC code. The purchaser, after attaining a certain number of proofs, then sends them to the manufacturer of the pet food to notify them of the purchases. Of course, the purchaser would identify himself or herself to the manufacturer so that further steps by the manufacturer could be taken, as described hereinafter.

In another embodiment of the notification procedure as described above, a method of collecting information from the pet food package and entering it into an online source is disclosed. It is envisioned that the purchaser of the pet food collects information from the pet food package itself, such as for example a code printed on the package. Such codes are well known in the art for entry into websites for rewards or prizes for the consumer or purchaser. Thus, similarly, the purchaser of the pet food, after collection or identification of the code from the package, goes to a website of the manufacturer, creates a username for identification purposes, and enters the code so that it is associated with the created username. The manufacturer is then able to identify the purchase and associate it with the username and with the purchaser. The manufacturer then takes further steps, as described hereinafter, so that the purchaser can receive the rebate or other form of discount.

In still another embodiment of the notification procedure as described above, a loyalty or rewards card that allows for tracking of purchases is disclosed. Such a rewards card is well known in the art and is used by many retailers to track purchasers of consumers so that a reward or loyalty benefit can be given to the consumer. Such a loyalty card, such as for example an Iams™ branded loyalty shopping card, is equally applicable and is envisioned for the notification procedure in this embodiment. The loyalty card can be used by the purchaser whenever a purchase of pet food or other product is made, and the card can be scanned or swiped, like other loyalty cards or credit cards, when checking out of a retail store, resulting in the purchases being tracked. Once scanned or swiped, the retailer's computer system can send the purchase information back to the manufacturer of the pet food so that notification to the manufacturer of the purchase is completed. The manufacturer then takes further steps, as described hereinafter, so that the purchaser can receive the rebate or other form of discount.

In still yet another embodiment of the notification procedure, another form of loyalty or shopper card can be utilized. In this embodiment, the manufacturer of the pet food could use the loyalty card of the retailer for tracking purposes. For example, if a pet food is purchased, and the loyalty card of the retailer is scanned, that purchase of the pet food could be tracked in the retailer's rewards system, and such information as the purchase and the purchaser could then be sent to the manufacturer. In this embodiment, a separate loyalty card for the manufacturer is not required, and thus the customer can simply use one loyalty card for the notification procedure.

### Receiving a Report

After a purchaser notifies or reports a purchase, the manufacturer can receive the report of the purchase. As above with the notification of the report, the receiving of the report can include any number of potential channels of communication and can parallel that channel of communication that the purchaser used to report the purchase. For example, if the purchaser sent in a certain number of proofs of purchase from the pet food package, the receiving of the report can include receiving by mail of the certain number of proofs of purchase. Likewise, if the purchaser uses a loyalty card or inputs information through the internet, it is envisioned that the manufacturer can receive that report through similar channels.

### Validate

Upon providing a pet food for purchase by a purchaser and providing a procedure whereby the purchaser can notify the manufacturer of the purchase, one embodiment of the present invention envisions that the manufacturer determines whether the purchase (that it was notified of as above) was valid and meets certain requirements. Thus, upon notification of the purchase and identification of the purchaser and the type of product purchased, the method can include the manufacturer determining whether the purchase is valid and meets certain requirements, such as a threshold requirement, wherein the requirement can comprise a minimum number of valid purchases by the purchaser.

Determining whether the purchase is valid can simply be a matter of the manufacturer verifying that the purchase did take place and that it has the necessary information to move forward with the method. The validity could be determined by a computer or a system configured to receive the notification, as above, and verifying that it has the necessary information to move forward. Such necessary information could include: the purchaser's name and address so that the purchaser can be contacted in the future for providing of a rebate and the type and brand of product so that the manufacturer can confirm that the type and brand of product is eligible under the method.

After validating the purchase, or simultaneously with validating, or even before validating, the manufacturer can determine whether the purchase meets certain requirements. Certain requirements can include any type of threshold or stipulations that the manufacturer deems to associate with their method. For example, a threshold requirement can comprise a minimum number of valid purchases by the purchaser. The manufacturer may state that in order to receive a rebate or a discount, a purchaser must purchase and present ten (10) proofs of purchase of a certain pet food, or spend $100 (one-hundred dollars) on a certain brand of product, before a rebate or discount can be given. Thus, the manufacturer will check against its requirements whether the purchaser has met the requirement. If, for example, the requirement is ten (10) proofs of purchase of a certain brand of pet food, and the purchaser has met the ten (10) purchase requirement, then the manufacturer would continue with the method. If, for example, the requirement has not been met, the manufacturer would wait until such a requirement is met before proceeding further. However, it is also envisioned the manufacturer may periodically inform the purchaser of the purchasers and inform them that they are within a certain number of purchasers of the stated threshold requirement. For example, if threshold requirement was $100 of pet food, and a purchaser reached $95 in pet food spending, the manufacturer may inform the purchaser, through a mailer, a note on a receipt from the retailer, or any other method, that they are within $5 of pet food spending to receive a rebate or discount.

### Rebate

Upon providing a pet food for purchase by a purchaser, providing a procedure whereby the purchaser can notify the manufacturer of the purchase, and determining that the purchase was valid and meets certain requirements, it is envisioned in at least one embodiment that the method includes providing a rebate to the purchaser. At this point, the manufacturer has confirmed a valid purchase and that it meets any requirements set by the manufacturer, and the manufacturer is in a position to reward the purchaser. To reward the purchaser, any number of a variety of ways can be utilized, such as a coupon, a discount card, cash, a check for a sum of money, a specific or special discount form that is used with a pet benefit provider, or any other form of a rebate or discount. It is envisioned is many embodiments that the reward be in the form of a financial discount. In at least one embodiment, it is envisioned that after the manufacturer has determined that a rebate should be provided to the purchaser, the manufacturer can simply mail them a check for a sum of money wherein the check must be used at a place of business of a pet benefit provider, such as a veterinarian or a retailer. In other embodiments, a discount is mailed to the purchaser such that the discount is in the form of a card that can be used to receive a discount on pet insurance. In still other embodiments, it is envisioned that the manufacturer provide to a pet insurance company a notice that the specific purchaser is eligible for a discount on pet insurance, and such a discount can be redeemed by the purchaser upon procuring a pet insurance policy. It should be understood that all combinations of rebate forms as described herein above and pet benefit providers are envisioned and within the scope of this invention. For example a coupon or any other form of rebate or discount sent by the manufacturer could be used at a retailer, with an insurance company, at a veterinarian, or any of the other pet benefit providers.

Other purposes of the rebate are envisioned. For example, it is within the scope of at least one embodiment of the present invention that the rebate or discount be used on a veterinarian visit. Such a rebate or discount would decrease the final cost of the veterinarian visit bill. Other examples include a discount on a basic wellness checkup, a discount on a veterinarian surgery or any other service or product offered by a veterinarian, a discount on a product offered for sale by a pet benefits provider, and a discount for a pharmaceutical for a pet.

### Redemption

A purchaser who receives a rebate as described hereinabove can then redeem the rebate in any number of ways. Generally, the form of the rebate can dictate the potential way that a purchaser will redeem it. For example, if the rebate is in the form of a discount card for use with insurance, the purchaser, after having received the rebate from the manufacturer, can simply present the discount card to an insurance company for purchase of an insurance policy at a discounted rate. If the rebate is in the form of a coupon for use at a retailer, the purchaser will simply use the coupon on a purchase of a pet product at the retailer by presenting it to a retailer. Other forms include putting dollars to be used onto the loyalty card described hereinabove such that when the loyalty card is scanned at a pet benefits provider, a discount is presented to the purchaser.

### Results

As a result of the method described hereinabove, it is envisioned that decreasing the cost of providing pets with benefits will be attained. It is believed that such decreasing costs associated with certain pet benefits will increase the probability that a purchaser will provide his or her pet with benefits that they may not ordinarily provide because the cost of those benefits may be an obstacle or barrier. For example, pet insurance, while not widely purchased, may become more and more affordable due to the decreased costs associated with the methods described hereinabove. Furthermore, wellness checkups may become more frequent for a pet because the cost to the purchaser has been decreased because of the methods described hereinabove. Moreover, having such a method in place may also create loyalty to a particular brand of pet food or other pet product because that specific pet food brand supplies the aforementioned financial discounts. Such loyalty means the purchaser is receiving more discounts, which in turn means that the pet is receiving more and more benefits because the purchaser would ideally be using those financial discounts for their pet. Lastly, the particular brand of pet food may also inherently be a more nutritious, healthy pet food, and, with increased purchasing and consumption by the pet of more nutritious, healthy pet food, the pet will become a healthier pet for eating more often the specific brand of pet food. In the end, improvement of the pet's health is achieved due to the methods of the present invention.

While time constraints have not specifically been heretofore mentioned, it should be understood that such constraints may or may not be imposed. For example, it may be advisable or preferred that a manufacturer or even a pet benefits provider may constrain a purchaser to purchase a certain quantity of bags of pet food, for example, in a certain period of time in order to receive a rebate or discount. It should be understood that any and all such time constraints are envisioned in this description. For example, a manufacturer may state that in order to receive a discount for pet insurance, the purchaser must make ten purchases of pet food within a two-year time period and submit the ten proofs of purchases within six-months of the last purchase. Such a time constraint thus would not allow such a rebate or discount program to run for eternity. Other time constraints are also envisioned, such as those placed by the pet benefits provider, which would be similar to those outlined just above.

It should further be understood that while the description above generally describes a consumer purchasing a pet food and thereafter receiving a financial discount with a pet benefits provider, such as a pet insurance company, another embodiment of the invention includes an insurance company providing a financial discount to the consumer. In such an embodiment, an insurance company can provide to the consumer recommendations on which brand pet food to purchase, or any other pet product, and then based on that recommendation, the consumer can purchase the recommended pet food. Upon purchase, and through procedures outlined hereinabove, the consumer can receive a financial discount on pet insurance based on the purchase of the recommended pet food. The financial discount can be given to the consumer in any number of ways. The discount can be on the pet food product, the pet insurance, or in combination, such that the total cost of the pet food product and the pet insurance is less when combined over a particular time period. The pet food recommendation by the pet insurance company could be based on many factors, including the type of pet that the consumer owns. Other factors could include that the pet insurance company is aware or has reason to believe that certain brand pet foods are healthier and better for certain animals and thus result in healthier animals, which results in less healthcare needs for the pet. In turn, the pet insurance company pays less in healthcare bills, and thus the consumer can be rewarded in a lower premium.

It should further be understood that while the description above and the examples that follow relate generally to pets and the pet industry, the disclosure and teachings therein have broad applicability across multiple continuums, including human uses.

### EXAMPLES

### Example 1

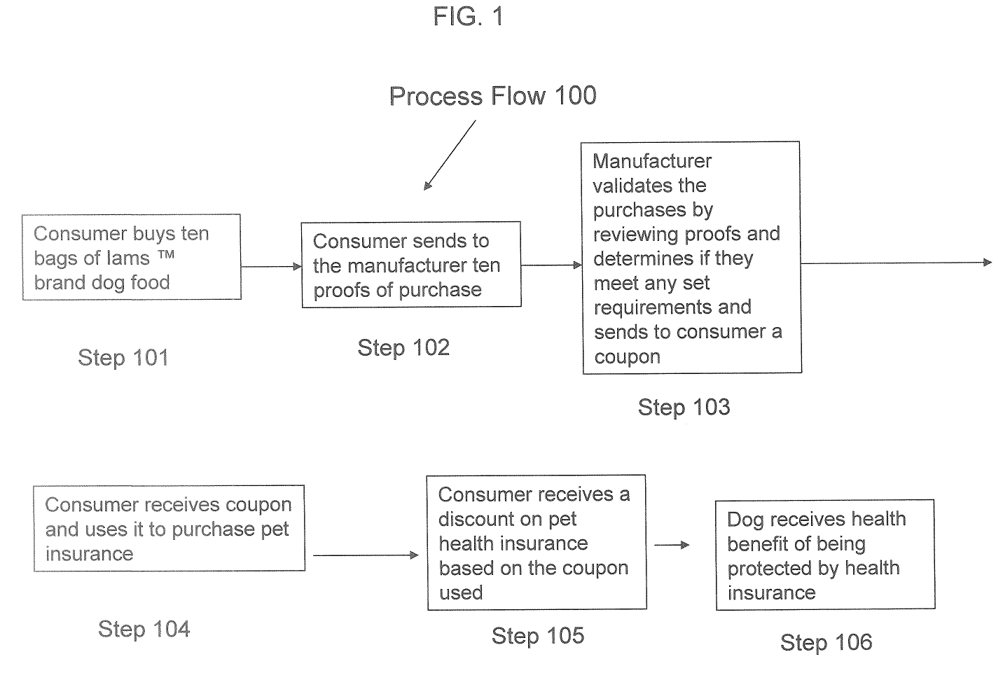

FIG. 1 depicts one example of a non-limiting embodiment of the present invention. Process flow 100 represents one method in accordance with one embodiment of improving the health of a pet.

In this example, a requirement of ten proofs of purchase is set by the manufacturer, and this requirement can be met by sending in ten proofs of purchase of dog food under the Iams™ brand name. Step 101 indicates that a consumer, or purchaser, buys ten bags of a pet food from a retailer. After purchasing ten bags of dog food, the consumer sends in ten proofs of purchase, one each from each bag of pet food, to the manufacturer of the pet food, as shown in step 102. In step 103, the manufacturer of the pet food validates the purchases by reviewing the proofs of purchase, determines that the ten proofs requirement was met, and sends to the consumer a coupon for 20% off pet insurance through a specific insurance carrier. Step 104 shows that the consumer receives the coupon and uses it to purchase pet insurance through the carrier. The carrier applies the 20% discount to the total cost of the pet insurance, resulting in the consumer receiving a 20% reduction in the cost of the insurance, as shown in Step 105. In step 106, the pet then receives the health benefit of being protected by health insurance, which may not have been provided was it not for the 20% discount received due to the purchases of pet food and the resulting rebate from the manufacturer.

### Example 2

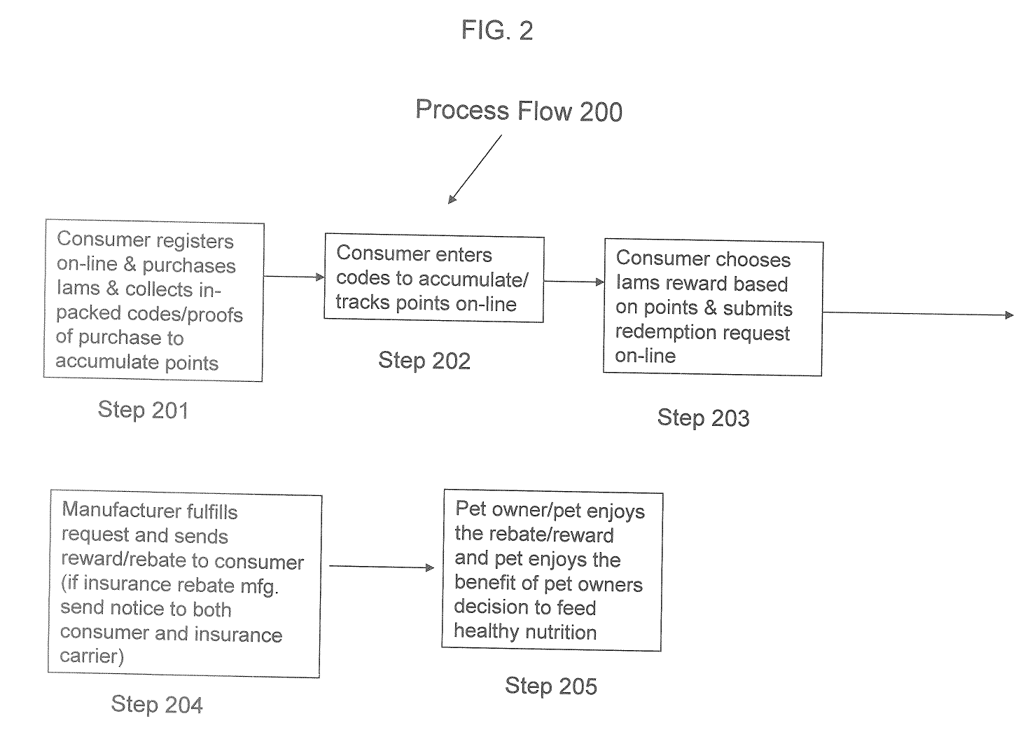

FIG. 2 depicts an example of a non-limiting embodiment of the present invention. Process flow 200 represents one method in accordance with one embodiment of improving the health of a pet.

In this example, a requirement of ten in-packed codes is set by the manufacturer, and this requirement can be met by collecting and tracking unique in-packed codes/proofs of purchase of dog food under the Iams™ brand name via the manufacturer's website. Step 201 indicates that a consumer or purchaser buys ten bags of food and registers their pet and their preferred contact method on www.Iams.com in accordance with the manufacturer's online privacy/security policies. In step 202, the consumer enters the in-packed unique code on the site to accumulate or track their points online. In step 203, consumer chooses a reward based on the number of accumulated points and submits their redemption request online. In step 204, the redemption request is fulfilled and sends the consumer a reward or rebate. If the reward is an insurance rebate, the notice can be sent to both the consumer and the insurance company so that both are aware of the award. In Step 205, the pet then receives the health benefit of being protected by health insurance and also enjoys the benefit of the pet owner's decision to feed the pet healthy nutrition.

### Example 3

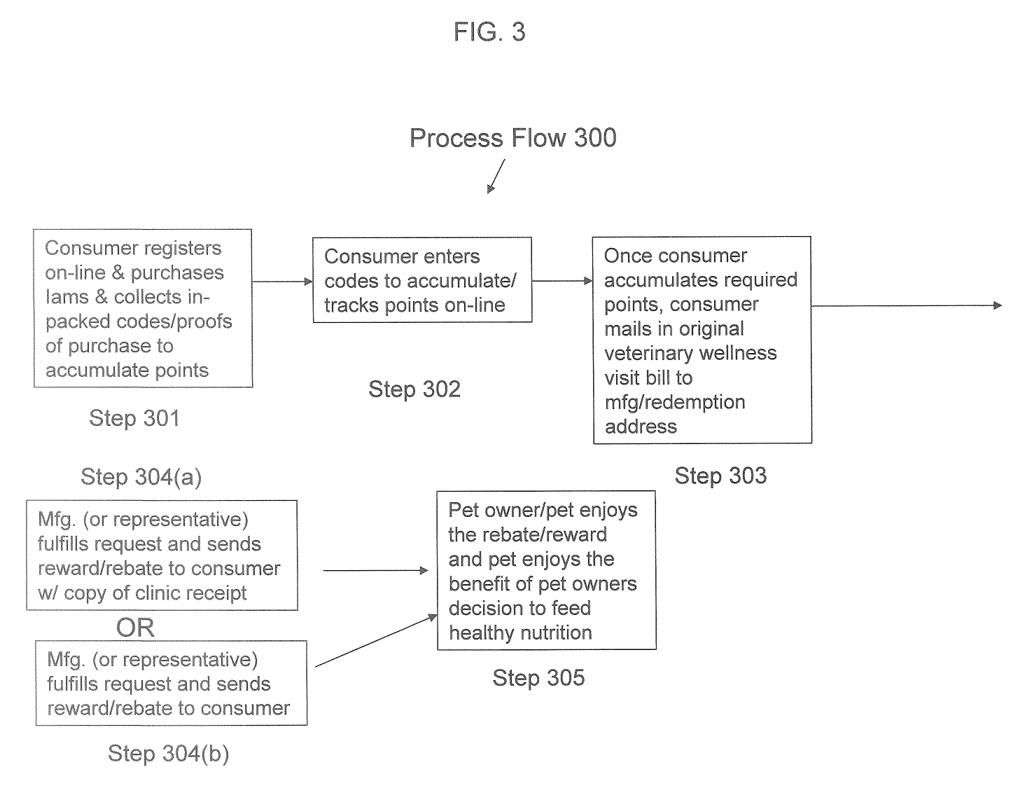

FIG. 3 depicts an example of a non-limiting embodiment of the present invention. Process flow 300 represents one method in accordance with one embodiment of improving the health of a pet.

In this example, a requirement of ten in-packed codes is set by the manufacturer, and this requirement can be met by sending in ten proofs of purchase of dog food under the Iams™ brand name. Step 301 indicates that a consumer or purchaser buys ten bags of food registers their pet and their preferred contact method on www.Iams.com in accordance with the manufacturer's online privacy/security policies. In step 302, the consumer enters and tracks the in-packed unique codes on the website. In step 303, the manufacturer of the pet food validates the purchases by reviewing the proofs of purchase, determines that the ten proofs requirement was met, and sends to the consumer a coupon for 20% off veterinary wellness visit/checkup through a participating Iams™ brand clinic. In Step 304(a), the consumer purchases a wellness visit and sends in the original receipt from the participating clinic (dollar amount can be limited up to a certain dollar figures for example $20) of the total cost of the wellness visit and/or services rendered to the manufacturer. The manufacturer then mails a rebate check to the consumer (dollar amount can be limited up to a certain dollar figure, for example $20) to the total cost of the wellness visit and/or services rendered to the consumer. Alternatively, in step 304(b), the manufacturer, upon verifying the necessary proofs of purchase has been made, sends a rebate directly to the consumer. In step 305, the pet then receives the benefits of being regularly seen by a veterinarian, which may not have been provided was it not for the 20% discount received due to the ten purchases of pet food.

### Example 4

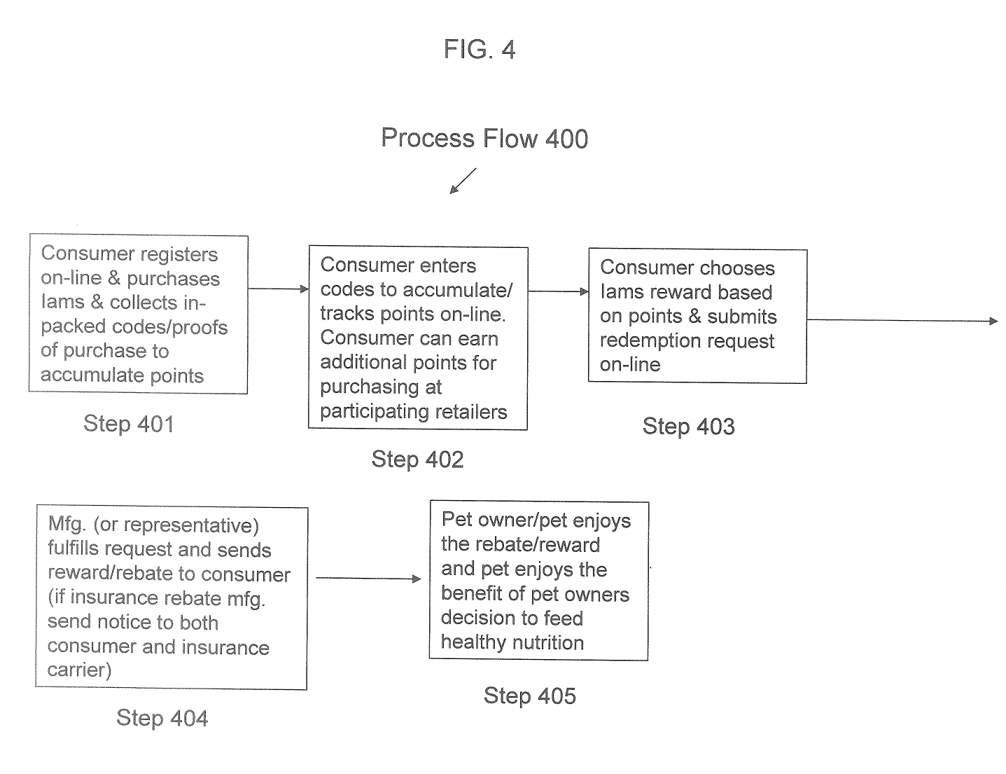

FIG. 4 depicts an example of a non-limiting embodiment of the present invention. Process flow 400 represents one method in accordance with one embodiment of improving the health of a pet.

In this example, a requirement of predetermined number of proofs of purchase/in-packed codes or accrued points is set by the manufacturer, and this requirement can be met by sending in proofs of purchase of dog food under the Iams™ brand name. Step 401 indicates that a consumer or purchaser buys bags of food and registers their pet and their preferred contact method on www.Iams.com in accordance with the manufacturer's online privacy/security policies. In step 402, the consumer enters the in-packed unique code on the site that specifies the participating retailer where the purchase of pet food was made. The purchaser or consumer mails in register receipts/unique customer codes from a participating retailer. In this example, the consumer can earn additional points for purchasing at certain participating retailers. Upon successfully accruing enough points, the customer can choose rewards for free products, discounts, or services at that participating retailer. As seen in step 403, the manufacturer validates the purchases by reviewing the proofs of purchase/unique codes, determines that the proofs requirement was met, and in step 404, sends to the purchaser a coupon for 20% off of select additional pet products or services through a participating Iams retailer. In step 405, the pet then receives the benefits of additional wellness products (i.e. crate, grooming tools or services), which may not have been possible it not for the 20% discount received due to the ten purchases of pet food.

### Example 5

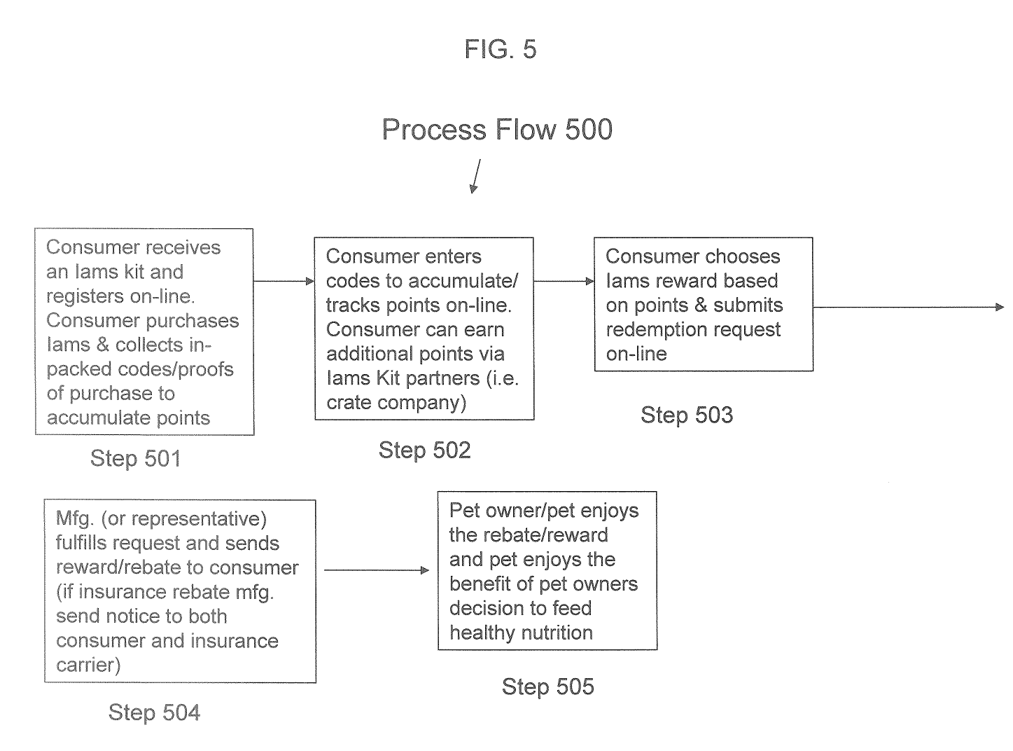

FIG. 5 depicts an example of a non-limiting embodiment of the present invention. Process flow 500 represents one method in accordance with one embodiment of improving the health of a pet.

In this example, upon receipt of a manufacturer's veterinary/shelter kit where the consumer received a pet, the consumer signs up on-line at www.Iams.com to start to accrue points worth discounts on goods/services at the veterinary clinic. A requirement of pre-determined number of proofs of purchase/in-packed codes or accrued points is set by the manufacturer, and this requirement can be met by sending in proofs of purchase of dog food under the Iams™ brand name. Step 501 indicates that a consumer or purchaser receives an lams puppy/kitten/weight/spay & neuter or other “kit” program at their veterinarian clinic and then buys bags of food. The consumer or purchaser would register their pet and their preferred contact method on www.Iams.com in accordance with the manufacturer's online privacy/security policies and enter the in-packed unique code on the site. In step 502, the manufacturer and a participating clinic partner on a loyalty program by which the purchase of pet food accrues points that can then be redeemed for free products, discounts, or services at that participating clinic. The purchaser or consumer enters in unique codes on the manufacturer's website. Additional points can be accrued by purchasing partner products and services (i.e. Invisble Fence brand products, crates, leads, etc). As seen in step 503, the manufacturer validates the purchases by reviewing the proofs of purchase/unique codes, determines that the proofs requirement was met, and in step 504, sends to the purchaser a coupon for 20% off of select additional pet products or services. In step 505, the pet then receives the benefits of additional wellness products (i.e. crate, grooming tools, or services), which may not have been possible it not for the ten purchases of pet food.

### Example 6

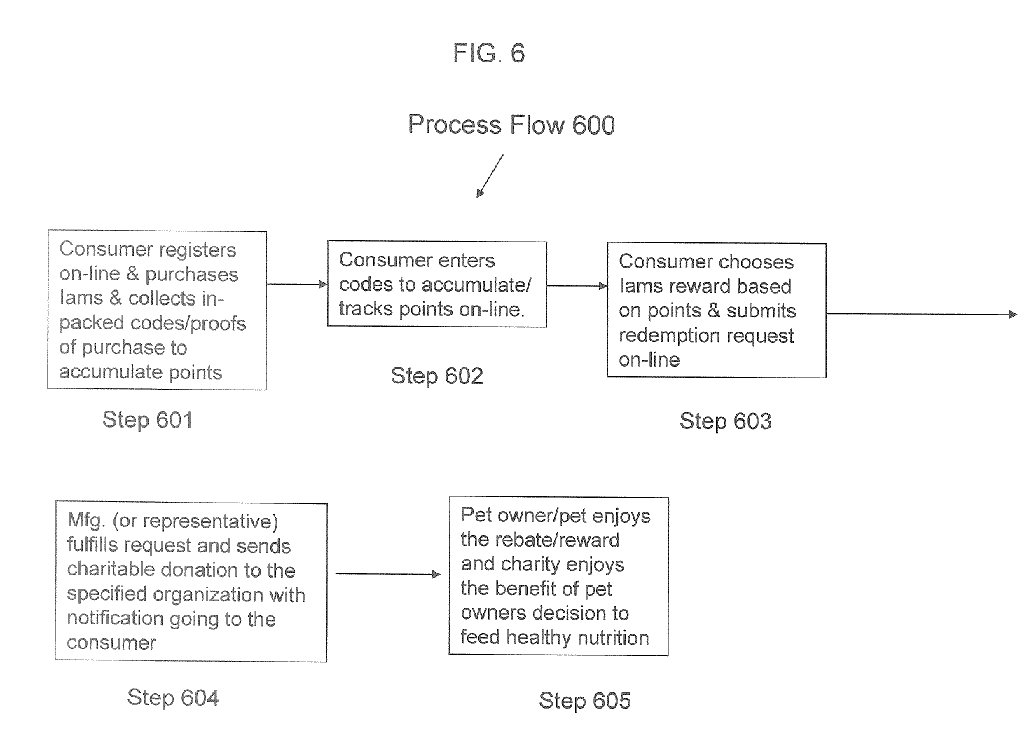

FIG. 6 depicts an example of a non-limiting embodiment of the present invention. Process flow 600 represents one method in accordance with one embodiment of improving the health of a pet.

In this example, a requirement of pre-determined number of proofs of purchase/in-packed codes or accrued points is set by the manufacturer, and this requirement can be met by sending in proofs of purchase of dog food under the Iams™ brand name. Step 601 indicates that a consumer or purchaser buys bags of food and registers their pet and their preferred contact method on www.Iams.com in accordance with the manufacturer's online privacy/security policies and in step 602 enters and tracks the in-packed unique code on the site. In step 603, upon successfully accumulating the appropriate number of points/purchases, the consumer designates their charitable cause as identified on the website. As seen in step 604, the manufacturer validates the purchases by reviewing the proofs of purchase/unique codes, determines that the proofs requirement was met, and sends a charitable donation to a specific charity (i.e. local shelter/national charity). In step 605, the consumer receives goodwill associated with making a charitable donation to a good cause as a result of buying pet food from the manufacturer.

### Example 7

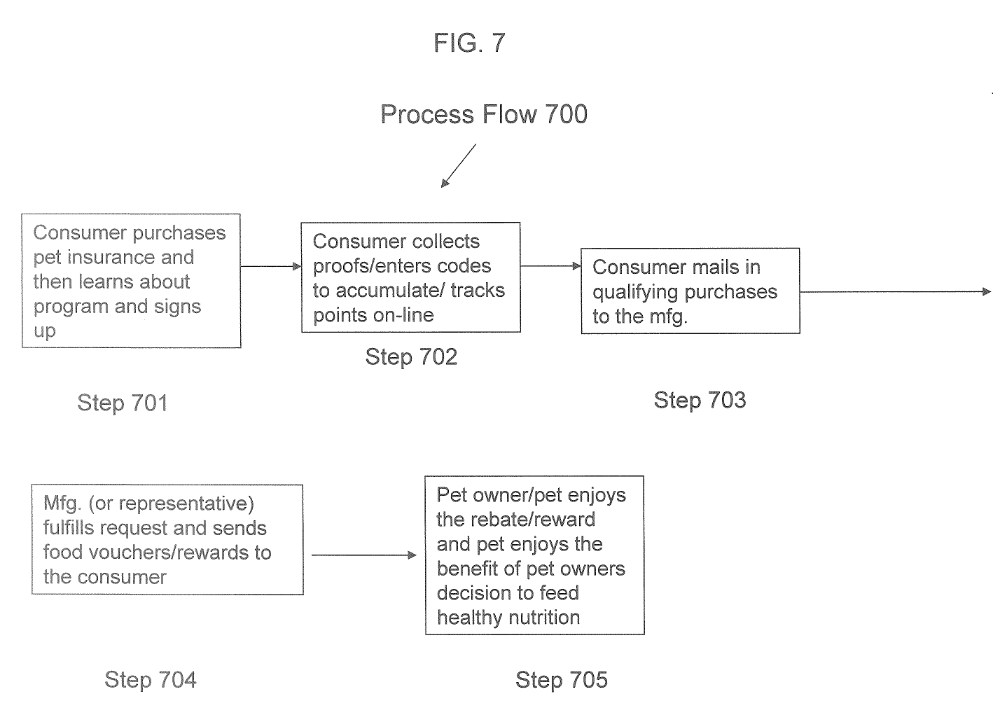

FIG. 7 depicts an example of a non-limiting embodiment of the present invention. Process flow 700 represents one method in accordance with one embodiment of improving the health of a pet.

In this example, a consumer purchases pet health insurance and learns that discounts or vouchers are available through the Iams company as the “preferred brand” of premium nutrition. In step 701, the consumer would sign up for the program and collect proofs of purchase through purchases of pet food of the Iams™ brand. In step 702, once a year, the consumer could mail in qualifying proofs of purchase good for discounts on premiums or free/discounted future pet food purchases from the manufacturer, in step 704. Step 705 shows that the pet owner and pet would the enjoy the discounts associated with the Iams™ brand pet food.

### Example 8

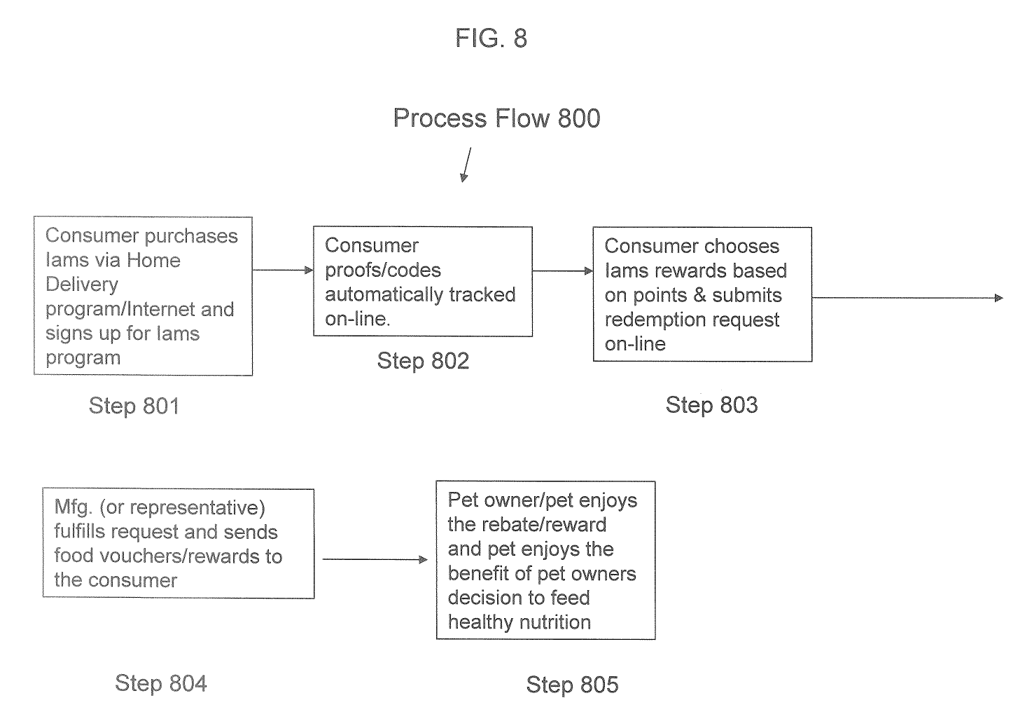

FIG. 8 depicts an example of a non-limiting embodiment of the present invention. Process flow 800 represents one method in accordance with one embodiment of improving the health of a pet.

In this example, a consumer signs up for direct-to-home delivery via the internet or other means in step 801. By enrolling in home delivery, the consumer is automatically eligible for food/insurance discounts as long as he/she continues in the program. Based on being signed up online, and with each online order, step 802 shows that the purchases would be automatically tracked by virtue of the ordering being done online. Step 803 shows that the consumer then chooses rewards based on the number of points accumulated through the online purchasing. Step 804 shows that the manufacturer then fulfills the request by sending rewards to the consumer. Step 805 shows that the poet owner and pet then enjoy the reward and the benefit of feeding the Iams™ brand product.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method comprising:
providing a pet food for purchase by a purchaser, wherein the pet food is manufactured by a manufacturer and sold to the purchaser by a retailer;
providing a procedure whereby the purchaser can report a purchase of the pet food;
receiving a report of a reported purchase;
determining whether the reported purchase is valid;
determining whether the reported purchase meets a threshold requirement, wherein the threshold requirement comprises a minimum number of valid purchases by the purchaser;
providing a rebate to the purchaser after determining whether the reported purchase is valid and determining whether the reported purchase meets a threshold requirement;
wherein the rebate is in the form of a financial discount for use with a pet benefits provider.

2. The method of claim 1 and wherein the pet benefits provider is selected from the group consisting of a pet insurance company, a veterinarian, and a pet products retailer.

3. The method of claim 1 and wherein the pet benefits provider is a pet insurance company.

4. The method of claim 3 and wherein providing the rebate comprises sending to the purchaser a financial discount for use with a pet benefits provider.

5. The method of claim 1 and wherein the pet benefits provider is a pet insurance company and wherein the rebate is a discount on pet insurance.

6. A method of improving a pet's health, the method comprising:
(a) providing a pet food within a package;
(b) providing a procedure whereby a purchaser of the pet food is able to identify the purchase of the pet food to one of a manufacturer or a retailer of the pet food;
(c) providing a rebate to the consumer after the purchaser identifies itself to the manufacturer;
wherein the rebate is usable as a discount with a provider of pet benefits.

7. The method of claim 6 and wherein the pet is selected from the group consisting of a dog, a cat, and a horse.

8. The method of claim 6 and wherein the procedure is in the form of sending in a proof of purchase of the pet food.

9. The method of claim 8 and wherein a minimum number of proofs of purchase must be attained before the step of providing a rebate to the consumer occurs.

10. The method of claim 6 and wherein the procedure is in the form of inputting information from the package into a website so that identification of the purchase can be made.

11. The method of claim 6 and wherein the procedure is in the form of a loyalty program card.

12. The method of claim 6 and wherein the provider of pet benefits is selected from the group consisting of a pet insurance company, a veterinarian, and a pet products retailer.

13. The method of claim 6 and wherein the rebate is in the form of a discount on pet insurance redeemable by the purchaser.

14. The method of claim 6 and wherein the rebate is in the form of a discount on a veterinarian visit.

15. The method of claim 14 and wherein the discount is for a wellness checkup.

16. The method of claim 14 and wherein the discount is for a veterinarian medical procedure.

17. The method of claim 6 and wherein the discount is for use at a pet products retailer.

18. The method of claim 6 and wherein the rebate is in the form of a discount for a pharmaceutical for the pet.

19. A method comprising:
(a) providing a recommendation to a consumer, whereby the recommendation comprises informing the consumer of a pet food to purchase;
(b) validating that the consumer made a purchase based on the recommendation;
(c) providing a financial discount to the consumer.

20. The method of claim 19 and wherein the financial discount comprises a financial discount on pet insurance.
